(19) United States
(12) Patent Application Publication
(10) Pub. No.: US 2007/0153007 A1
(43) Pub. Date: Jul. 5, 2007

(54) Method, processing system and computer system for sparse update displays

(75) Inventors: Lawrence A. Booth JR., Phoenix, AZ (US); Kelley T. Johnson, Westford, MA (US); Ralph Martin Mesmer, Banks, OR (US)

Correspondence Address: INTEL CORPORATION;c/o INTELLEVATE, LLC, P.O. BOX 52050, MINNEAPOLIS, MN, 55402, US

(73) Assignee: Intel Corporation

(21) Appl. No.: 11/322,902

(22) Filed: Dec. 29, 2005

(51) Int. Cl. G06T 1/00

(52) U.S. Cl. 345/501

(57) ABSTRACT

Some embodiments of a method, processing system and computer system are described for sparse updating of displays. The graphics system includes a processing system, which has a video decoder to operate with a display controller. The video decoder and/or display controller may include logic for shutting down portions of the graphics system and for sending reduced video data to a display. In some embodiments, the graphics system sends signals to shut down portions of the display. In some embodiments, parts of the graphics system, computer system and display are able to shut down when there is not a difference in the video data to be sent to the display. In some embodiments, the amount of video data to be sent to the display is reduced during encoding and/or decoding by only sending the video data which is different. Other embodiments are described.

### CROSS-REFERENCE TO RELATED APPLICATIONS

The present application may be related to subject matter disclosed in the following patent application that is commonly-owned:

U.S. patent application Ser. No. ______, (Attorney Docket No. P23194), “Method, Display, Graphics System and Computer System for Sparse Update Displays,” filed concurrently herewith.

### BACKGROUND

1. Technical Field

Some embodiments of the invention generally relate to graphics systems and displays used with computer systems. More specifically, some embodiments relate to power efficient operation of graphics systems and displays.

2. Discussion

In recent years, efforts have been made to reduce the power requirements of computing devices. For mobile or portable devices operating from a battery or other constrained power supply, the efforts are directed to increasing the operational time of the device by prolonging the viability of the battery. Increasingly, there have been efforts to reduce the power requirements of all computing devices, for at least environmental reasons.

Conventional computing devices include at some point a display device. Display devices are typically one of the largest power consumers of a computing system.

Therefore, there is a need for a graphics system and parts thereof that provides advantages for power efficient displays.

### BRIEF DESCRIPTION OF THE DRAWINGS

Various advantages of embodiments of the present invention will become apparent to one of ordinary skill in the art by reading the following specification and appended claims, and by referencing the following drawings, in which:

FIG. 1 illustrates a computer system with a graphics system and a display according to some embodiments of the invention;

FIG. 2 illustrates a computer system with a graphics system and a display according to some embodiments of the invention;

FIG. 3 illustrates a computer system with a graphics system and a display according to some embodiments of the invention;

FIG. 4 illustrates a flowchart of operations of the graphics system and display according to some embodiments of the invention;

FIG. 5 illustrates a flowchart of the operation of sparsely updating parts of the graphics system and the display according to some embodiments of the invention; and

FIG. 6 illustrates a computer system according to some embodiments of the invention.

### DETAILED DESCRIPTION

Reference is made to some embodiments of the invention, examples of which are illustrated in the accompanying drawings. While the invention will be described in conjunction with the embodiments, it will be understood that they are not intended to limit the invention to these embodiments. On the contrary, the invention is intended to cover alternatives, modifications and equivalents, which may be included within the spirit and scope of the invention as defined by the appended claims. Moreover, in the following detailed description of the invention, numerous specific details are set forth in order to provide a thorough understanding of the invention. However, the invention may be practiced without these specific details. In other instances, well-known methods, procedures, components and circuits have not been described in detail as not to unnecessarily obscure aspects of the invention.

Some embodiments of a method, processing system and computer system are described for sparse updating of displays. The graphics system includes a processing system, which has a video decoder to operate with a display controller. The video decoder and/or display controller may include logic for shutting down portions of the graphics system and for sending reduced frame data or video data to a display. The terms ‘video data’ and frame data’ are used interchangeably. In some embodiments, it may be convenient to think of video data as potentially including information about more than one frame of video; and frame data as including information about a single frame, but this is not a strict classification of the terms. Rather, as one of ordinary skill in the relevant art would appreciate, the terms are used to inform the reader of the focus of the components or processes of the embodiments of the invention, such as, the data being processed.

In some embodiments, the graphics system sends signals to shut down portions of the display. In some embodiments, parts of the graphics system, computer system and display are able to shut down when there is not a substantial difference in the frame data to be sent to the display. In some embodiments, the amount of frame data to be sent to the display is reduced during encoding and/or decoding by only sending the frame data which is substantially different. Other embodiments are described, for example, the use of encoders/decoders as part of the reduced amount of frame data sent through the graphics system to the display.

Indeed, reference in the specification to an embodiment or some embodiments of the invention means that a particular feature, structure or characteristic described in connection with the embodiment is included in at least one embodiment of the invention. Thus, the appearances of the phrase “in some embodiments” or “according to some embodiments” appearing in various places throughout the specification are not necessarily all referring to the same embodiment.

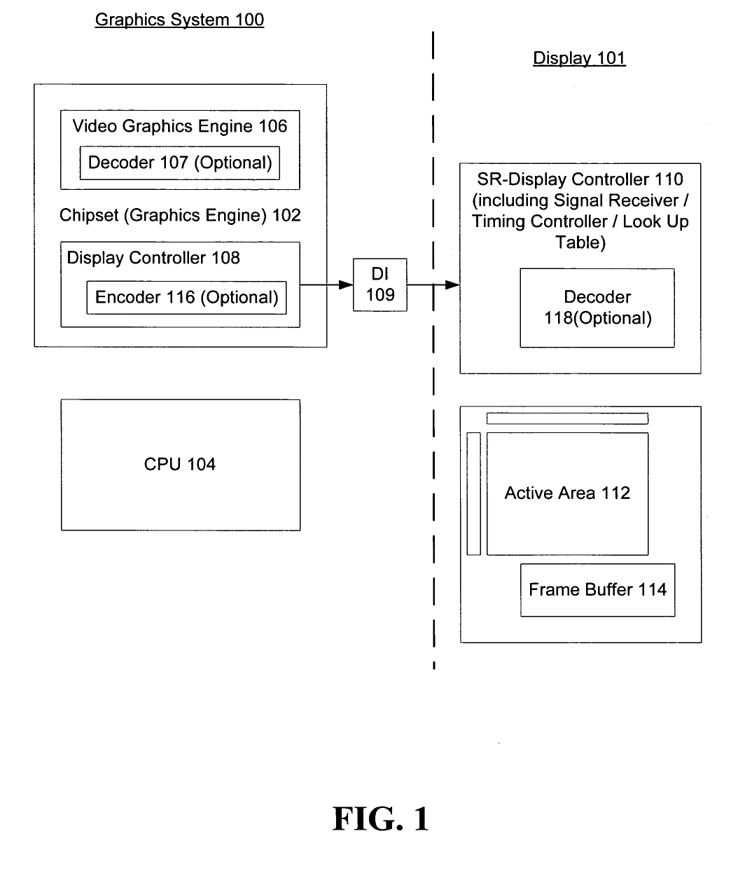

FIG. 1 illustrates a computer system with a graphics system 100 and a display 101 according to some embodiments of the invention. The computer system may include one or more central processing units (CPUs) 104, according to some embodiments of the invention. The CPU 104 may include one or more processing cores and may be manufactured by Intel® Corporation. In some embodiments, the CPU 104 may be manufactured by another, as one of ordinary skill in the art would appreciate.

According to some embodiments of the invention, the graphics system 100 may include a chipset 102, which may also provide a graphics engine through a combination of hardware and software/firmware, as one of ordinary skill in the relevant art(s) would appreciate based at least on the teachings provided herein. In some embodiments, the chipset 102 may also be called a processing system, and may include a video graphics engine 106 and a display controller 108. The engine 106 may include an optional decoder 107 to decode video data, according to some embodiments of the invention. Indeed, as one of ordinary skill in the relevant art would appreciate, based at least on the teachings provided herein, the engine 106 may always decode video data in some manner, yet it is not required by the embodiments of the invention to have a distinct decoder as shown. The display controller 108 may include an optional encoder 106 to encode video data, according to some embodiments of the invention. The graphics system 100 may include a display interface (DI) 109, according to some embodiments. The DI 109 may provide video data from the chipset 102 to the display 101. The DI 109 may communicate using low-voltage differential signaling (LVDS) to and/or from the graphics system and the display, as one of ordinary skill would appreciate.

In some embodiments, the frame data or video data, as one of ordinary skill appreciates the operation of the components of the graphics system 100 based at least on the teachings described herein, may be forwarded to the display 101 via DI 109. The display 101 may include a self-refresh (SR) display controller 110. In some embodiments, the SR-display controller 110 may include, among other things, a signal receiver, such as, but not limited to a LVDS receiver, a timing controller, and a look up table (LUT). Furthermore, according to some embodiments of the invention, the controller 110 may include an optional decoder 118 to decode the frame data received from the DI 109.

In some embodiments of the invention, the controller 110 may provide the frame data to an active area 112 of the display for the formation of one or more images. The controller may also provide the frame data to a frame buffer 114 which may store the frame data, according to some embodiments of the invention.

According to some embodiments of the invention, the display controller 110 may be a liquid crystal display (LCD) controller, a cathode ray tube (CRT) controller, or equivalent controller with the additional functions of the embodiments of the invention, as one of ordinary skill in the relevant art would appreciate based at least on the teachings described herein. Furthermore, the display 101, in some embodiments, may be a LCD or CRT display, or an equivalent display, such as a plasma display, including various types of these displays, for example, a low temperature poly silicon (LTPS) LCD display.

In some embodiments of the invention, the graphics system 100 may include the display controller 108. The display controller 108 may include logic, either in software, hardware, or an operational equivalent, that sends a shut down signal to the display 101, and shuts down one or more components of the graphics system 100, wherein the graphics system includes at least a display interface. In some embodiments, the logic may also wake up the one or more components, such as, but not limited to, the chipset 102, engine 106, display interface 109, and/or display controller 108 of the graphics system 100, and re-synchronize the graphics system 100 with the display 101. Furthermore, in some embodiments, the logic may send a wake up signal to the display 101, and may also receive an acknowledgement from the display 101.

In some embodiments, the logic may send the shut down signal following a determination that a current frame data for the display is not different from a previous frame data. According to some embodiments of the invention, the difference between the current frame data and the previous frame data may be minor, such as, but not limited to, a difference of one or more pixels.

Furthermore, in some embodiments, the logic may wake up of the one or more components of the graphics system 100 following a determination that a current frame data for the display 101 is different from a previous frame data. According to some embodiments, the logic to determine whether there is a difference in the video data may be called a difference engine (not shown), and operate within display controller 108, and in conjunction with optional encoder 116 or the other components of the chipset 102 and DI 109.

As described elsewhere herein, the graphics system 101 may be thought of as including a processing system. According to some embodiments of the invention, the processing system may include a video decoder, such as but not limited to, decoder 107, wherein the video decoder may include a logic that receives encoded video data, may determine whether the video data is a reference frame, and when the video data is a reference frame, may write the video data to a display.

In accordance with some embodiments of the invention, when the video data is not a reference frame, the logic may process any bidirectional frames and/or predicted frames in the frame data, may determine whether one or more new motion vectors are present in the processed frames, when the new motion vector is present, may write primarily the video data for the one or more new motion vectors to the display, and may determine the end of the frame.

Furthermore, the processing system may include a display controller 108 to share one or more parts of the logic with the video decoder, according to some embodiments of the invention. In some embodiments, the logic may forward the frame data to a display interface, and it may encode the frame data or video data.

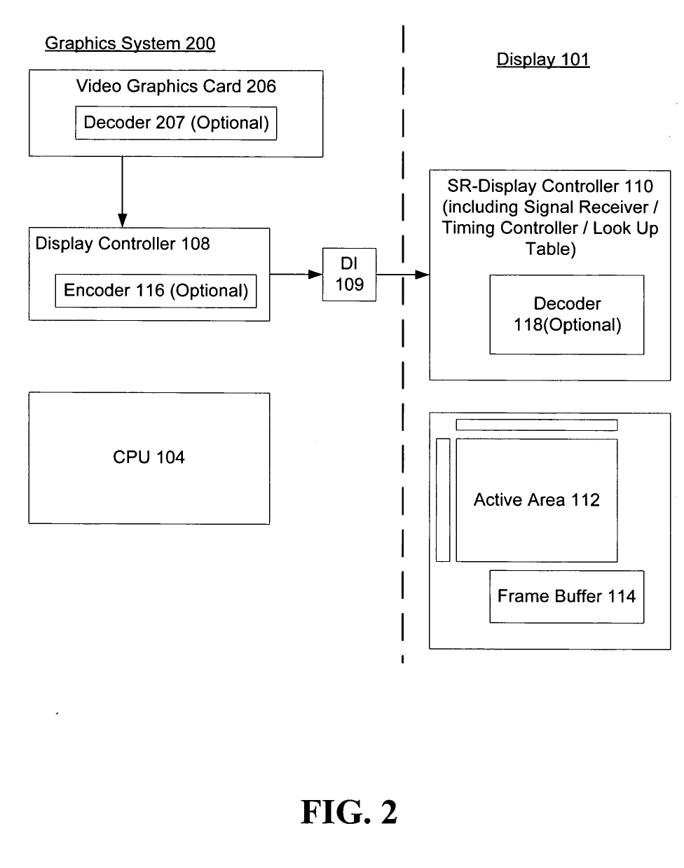

FIG. 2 illustrates a computer system with a graphics system 200 and the display 101 according to some embodiments of the invention. The graphics system 200 includes a different architecture than graphics system 100, yet it may, according to some embodiments of the invention, perform the identical functions as described elsewhere herein. Specifically, the graphics system 200 may include a video graphics card 206. The card 206 may include the display controller 108 or the controller 108 may be on a separate board or card (as shown), according to some embodiments of the invention. In some embodiments, the card 206 may include an optional decoder 207; and the controller 108 may include an optional encoder 116.

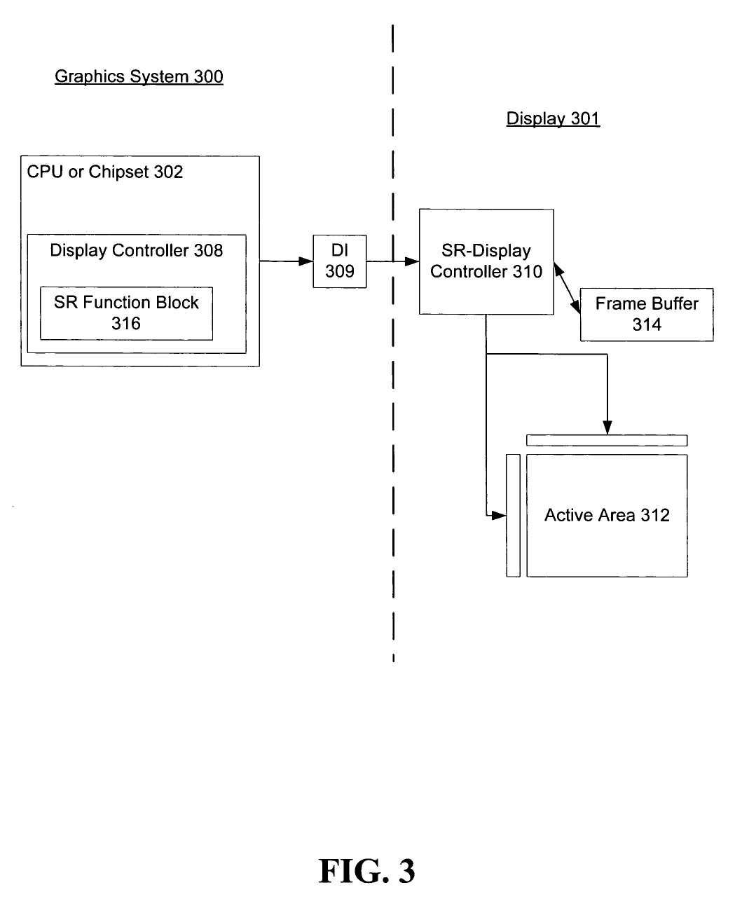

FIG. 3 illustrates a computer system with a graphics system 300 and a display 301, according to some embodiments of the invention. The graphics system 300 and the display 301 each include different architectures than the other systems and displays, yet they may, according to some embodiments of the invention, perform similar or identical functions as described elsewhere herein. Specifically, a CPU or chipset 302 may provide the base component of the graphics system 300, according to some embodiments. In some embodiments, the chipset 302 may include a display controller 308 to receive video data and provide the data to the DI 109. The display controller may include a self-refresh function block 316, which may also include a difference engine, as is described elsewhere herein, according to some embodiments of the invention.

In some embodiments, the SR function block 316 may determine if the current video data should be forward to the display 301, and, in some embodiments, may further determine when the DI 109 can be shut down.

In some embodiments, the display 301 may include a SR display controller 310. The controller 310 may receive either full or partial video data or frame data from the DI 109 and may store the data in a frame buffer 314, in some embodiments. The controller 310 may access the frame buffer 314 to provide one or more images for an active area 312, in some embodiments. In accordance with some embodiments of the invention, the controller 310 may access the frame buffer 314 when it does not receive data from the DI 109.

In some embodiments, the display 301 may include the self-refresh display controller 310, where the self-refresh display controller 310 may include logic that receives a shut down signal from a graphics system and shuts down one or more components of a display 301, activates a frame buffer to provide frame data for the display 301, and switches to the frame buffer when refreshing the display 301.

In some embodiments, the logic may synchronize the display 301 with the graphics system 300, and switches back to the graphics system 300 for frame data or video data. Furthermore, in some embodiments, the logic may activate the one or more components of the display 301, and may shut down the frame buffer.

In some embodiments, the logic may receive a wake up signal from the graphics system 300, and may send an acknowledgement to the graphics system 300. According to some embodiments, the self-refresh display controller 310 may further include a decoder to decode frame data, such as, but not limited to decoder 118.

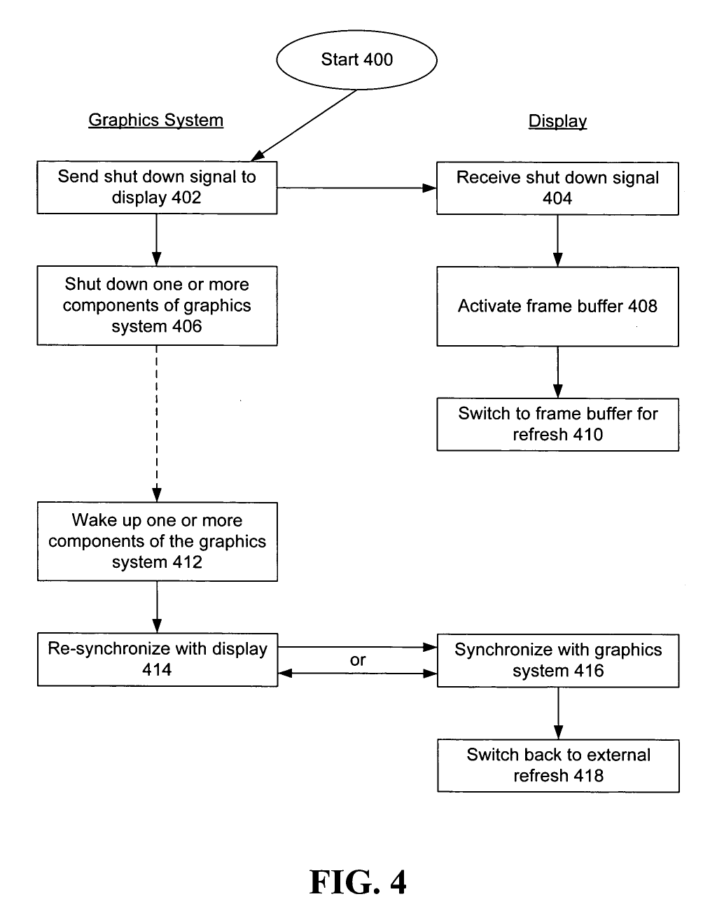

FIG. 4 illustrates a flowchart of operations of a graphics system and a display according to some embodiments of the invention. In some embodiments, the components of the graphics systems may perform operations starting at 400 and proceeding to 402. At 402, the process may send a shut down signal to a display (at 404, described below). The process may then proceed to 406, where it may shut down one or more components of a graphics system, wherein the graphics system includes at least a display interface.

According to some embodiments of the invention, the process may proceed to 412 and may wake up the one or more components of the graphics system. The process may then proceed to 414, in some embodiments, where it may re-synchronize the graphics system with the display. In some embodiments, the re-synchronizing of the graphics system with the display may further include sending a wake up signal to the display, and receiving an acknowledgement from the display.

According to some embodiments, the sending of the shut down signal may follow a determination that a current frame data for the display is not different from a previous frame data. Moreover, in some embodiments, the difference between the current frame data and the previous frame data may be minor, such that one or more pixels are different between the current and previous frame data or video data.

In some embodiments, the waking up of the one or more components of the graphics system may follow a determination that a current frame data for the display is different from a previous frame data.

As mentioned above with respect to the operation at 404, the display may receive a shut down signal from a graphics system and shutting down one or more components of a display. In some embodiments, the process proceeds to 408, where it may activate a frame buffer to provide frame data for the display; and then to 410, where it may switch to the frame buffer when refreshing the display.

Furthermore, the process may then proceed to 416, where it may synchronize with the display of the graphics system, according to some embodiments. The process may then proceed to 418, where it may switch back to the graphics system for frame data.

According to some embodiments of the invention, the synchronizing of the display with the graphics system may further include activating the one or more components of the display. Furthermore, in some embodiments, the switching back to the graphics system may further include shutting down the frame buffer. Moreover, in some embodiments, the synchronizing of the display with the graphics system may further include receiving a wake up signal from the graphics system, and sending an acknowledgement to the graphics system.

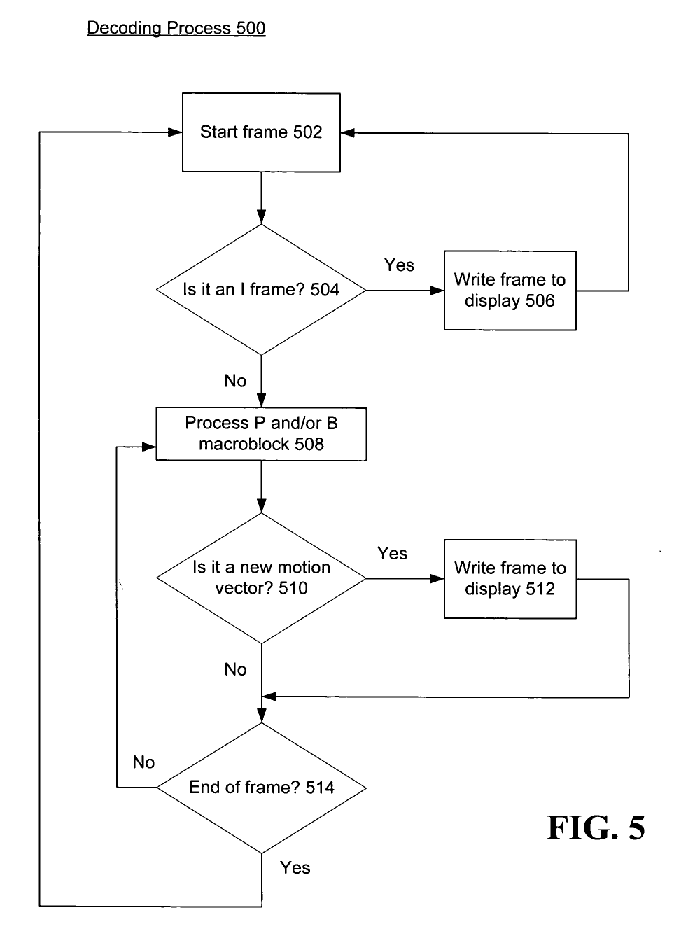

FIG. 5 illustrates a flowchart of the operation of sparsely updating parts of the graphics system and the display according to some embodiments of the invention. The operation of the decoding process 500 starts at 502, where it may receive frame data or video data, where video data may be data about one or more frames of video, in some embodiments of the invention. The process then proceeds to 504, where it may determine whether the video data is a reference frame, according to some embodiments of the invention.

In some embodiments, when the video data is a reference frame, the process proceeds to 506, where it may write the video data to a display, such as, but not limited to, display 101 or display 301. According to some embodiments, when the video data is not a reference frame, the process may proceed to 508, where it may process any bidirectional frames and/or predicted frames in the video data. The process proceeds to 510, where it may determine whether a new motion vector is present in the processed frames. In some embodiments, when the new motion vector is present, the process may proceed to 512, where it may write primarily the video data for the new motion vector to the display. In either case, the process may then proceed to 514, where it may determine the end of the frame. If it is not the end of the frame, the process may proceed back to 508. If it is the end of the frame, the process may proceed back to 502 where it may be performed again in whole or in part, as one of ordinary skill in the relevant art would appreciate based at least on the teachings provided herein.

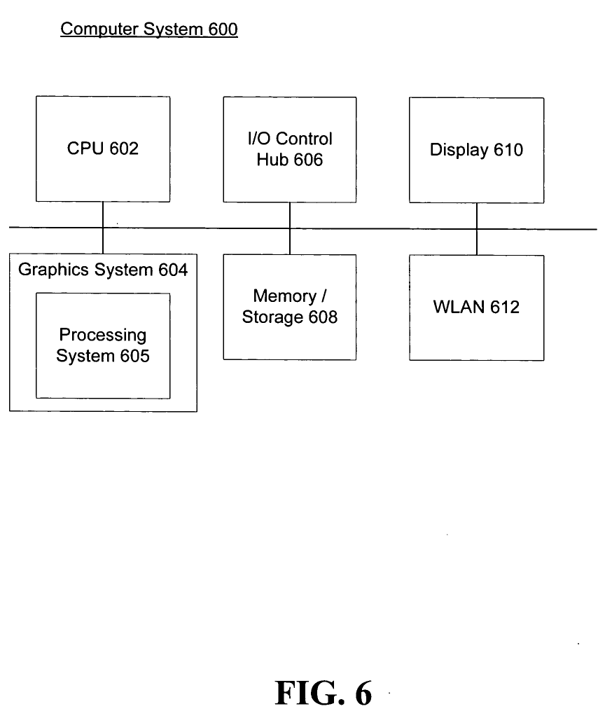

FIG. 6 illustrates a computer system 600, such as, but not limited to the computer systems of FIGS. 1-3, according to some embodiments of the invention. In some embodiments of the invention, the computer system 600 may include a CPU 602, such as a processor with one or more cores. The computer system 600 may also include a graphics system 604, such as, but not limited to the graphics systems of FIGS. 1-3, according to some embodiments. The graphics system 604 may include a processing system 605, as described elsewhere herein with regard to some embodiments of the invention. The processing system 605 may include, according to some embodiments, a display controller, where the display controller includes a logic that sends a shut down signal to a display, and shuts down one or more components of a graphics system, wherein the graphics system includes at least a display interface.

In some embodiments, the computer system 600 may include an input/output (I/O) control hub (ICH) 606, such as, but not limited to an ICHx, to provide management and access between and among various components of the computer system 600. Furthermore, the computer system 600 may include memory/storage 608, in some embodiments, which may include various types of random access memory (RAM), read-only memory (ROM), caches, and hard drives.

Moreover, the computer system 600 may include a display, such as, but not limited to displays 101 and 301, in some embodiments of the invention. In accordance with embodiments of the invention, the computer system 600 may also include a wireless local area network (WLAN) module 612 to provide access to network resources to the computer system 600, and a display interface, such as, but not limited to DI 109, to forward video data to a display.

Embodiments of the present invention may be described in sufficient detail to enable those skilled in the art to practice the invention. Other embodiments may be utilized, and structural, logical, and intellectual changes may be made without departing from the scope of the present invention. Moreover, it is to be understood that various embodiments of the invention, although different, are not necessarily mutually exclusive. For example, a particular feature, structure, or characteristic described in one embodiment may be included within other embodiments. Those skilled in the art can appreciate from the foregoing description that the techniques of the embodiments of the invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

What is claimed is:

1. A processing system comprising:
a video decoder, wherein the video decoder includes a logic that receives encoded video data, determines whether the video data is a reference frame, and when the video data is a reference frame, writes the video data to a display.

2. The processing system of claim 1, further comprising:
when the video data is not a reference frame, the logic processes any bidirectional frames and/or predicted frames in the video data, determines whether one or more new motion vectors are present in the processed frames, when the new motion vector is present, writes primarily the video data for the one or more new motion vectors to the display, and determines the end of the frame.

3. The processing system of claim 1, further comprising:
a display controller to share one or more parts of the logic with the video decoder.

4. The processing system of claim 1, wherein the logic forwards the video data to a display interface.

5. The processing system of claim 1, wherein the logic encodes the video data.

6. The processing system of claim 2, wherein the logic forwards the video data to a display interface.

7. The processing system of claim 2, wherein the logic encodes the video data.

8. A computer system comprising:
a display interface to forward video data to a display; and
a video decoder, wherein the video decoder includes a logic that receives encoded video data, determines whether the video data is a reference frame, and when the video data is a reference frame, writes the video data to the display interface.

9. The computer system of claim 8, further comprising:
when the video data is not a reference frame, the logic processes any bidirectional frames and/or predicted frames in the video data, determines whether one or more new motion vectors are present in the processed frames, when the new motion vector is present, writes primarily the video data for the one or more new motion vectors to the display interface, and determines the end of the frame.

10. The computer system of claim 8, further comprising:
a display controller to share one or more parts of the logic with the video decoder.

11. The processing system of claim 8, wherein the logic encodes the video data.

12. The processing system of claim 9, wherein the logic forwards the video data to a display interface.

13. The processing system of claim 9, wherein the logic encodes the video data.

14. The computer system of claim 8, further comprising:
a display.

15. The computer system of claim 8, further comprising:
a wireless local area network module.

16. A method comprising:
receiving video data;
determining whether the video data is a reference frame; and
when the video data is a reference frame, writing the video data to a display.

17. The method of claim 16, further comprising:
when the video data is not a reference frame, processing any bidirectional frames and/or predicted frames in the video data;
determining whether a new motion vector is present in the processed frames;
when the new motion vector is present, writing primarily the video data for the new motion vector to the display; and
determining the end of the frame.

18. The method of claim 16, wherein the writing of the video data to the display further includes forwarding the video data to a display interface.

19. The method of claim 16, wherein the writing of the video data to the display further includes encoding the video data.

20. The method of claim 17, wherein the writing primarily of the video data for the new motion vector to the display further includes forwarding the video data to a display interface.

21. The method of claim 17, wherein the writing primarily of the video data for the new motion vector to the display further includes encoding the video data.
